(19) United States
(12) Patent Application Publication
(10) Pub. No.: US 2005/0113944 A1
(43) Pub. Date: May 26, 2005

(54) Control method and system for machine tools and industrial vehicles

(76) Inventor: Danilo Santarossa, Azzano Decimo (IT)

Correspondence Address: David J. Simonelli;CLARK HILL Plc, Suite 3500, 500 Woodward Avenue, Detroit, MI, 48226-3435, US

(21) Appl. No.: 10/996,525

(22) Filed: Nov. 23, 2004

(30) Foreign Application Priority Data
Nov. 24, 2003 (IT) MI2003A002281

(51) Int. Cl. G05B 15/00

(52) U.S. Cl. 700/83; 340/825.72; 348/734; 345/169; 455/41.2; 700/17; 398/106

(57) ABSTRACT

Control method for members of machine tools or machinery installed on industrial vehicles comprising: providing a control unit on said machine tool or said industrial vehicle capable of controlling the various members of said machine tool or machinery installed on said vehicle; providing a remote unit, with touch screen functionality, capable of exchanging data via radio with said control unit, said remote unit being equipped with a memory and being programmable.

### FIELD OF THE INVENTION

The present invention relates to a method and a system for controlling machine tools and machinery installed on industrial vehicles, in particular for remote control of said equipment.

### PRIOR ART

In the case of machine tools, and, more often, in the case of industrial vehicles, on which particular machinery are installed, it is often necessary to be able to control the various members or machinery by means of a centralized control system. An operator must be able to operate the various controls from a single position. One example is vehicles equipped for draining cesspools. These are tankers equipped with various types of machinery, including a vacuum pump to produce a certain degree of vacuum inside a specific section of the tank, to allow suction of sewage using hoses, and a pressure pump suitable to deliver water (drawn from another section of the tank) at high pressure using a nozzle, for operations such as washing pipes, drains and the like. The two pumps are operated in various ways, for example by means of the engine of the vehicle or by an auxiliary engine. Other machinery or members may be provided, such as systems for connecting engine and pumps and varying the speed thereof . . . According to a possible solution, these machinery can be controlled by means of a control panel, which may be placed in different positions on the vehicle, for example on the outside of the compartment. However, this solution has the drawback that the fixed position of the panel does not allow remote control, while the operator generally needs to work some metres apart from the vehicle. Moreover, especially if control panels having a monitor to view information are used (for example, touch screen type systems), there can be problems related to poor visibility due, for example, to sunlight, in relation to the fact that the panel cannot be moved. The use of a common remote control unit would require, in the case of complex equipment like the given example, the transmission of an enormous amount of data between the remote control and a control unit positioned on the vehicle or machine tool. This is even more felt if the operator must be allowed to view data relative to machine operation, or to receive messages regarding the presence and nature of any faults and/or operate on a panel equipped with a monitor, on which a diagram of the equipment controlled can be viewed with indications of the various operating data and which may be used to perform commands by touching the various parts of the screen. In this case, data to be viewed would have to be transmitted continuously by the control unit to the remote control, which would be impossible on the normal serial channels commonly used in this type of data transmission, for example.

### SUMMARY OF THE INVENTION

The aforesaid problems have now been solved thanks by a method for controlling machine tools and/or machinery installed on industrial vehicles comprising:
providing, on said machine tool or said industrial vehicle, a control unit capable of controlling the various members of said machine tool or the machinery installed on said vehicle;
providing a remote unit capable of exchanging data via radio with said control unit, said remote unit being equipped with a memory and being programmable.

Preferably, the remote unit is equipped with a monitor with touch screen functionality.

According to a preferred aspect, the remote unit can receive, from the control unit, data relative to operation of the various members or machinery controlled and send commands to the control unit for the control of said members or machinery. The invention also relates to a control system for machine tools comprising a control unit and a remote control as described above.

The invention further relates to a machine tool or an industrial vehicle equipped with a control system as described above.

### LIST OF DRAWINGS

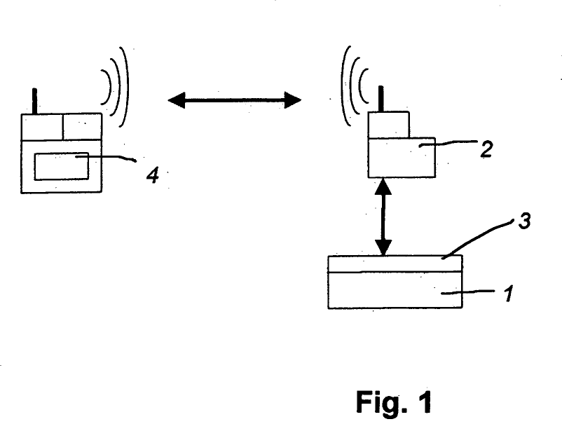

The present invention shall now be described by means of the detailed description of preferred, although not exclusive, embodiments, provided purely as an example, with the help of the appended FIG. 1 which schematically represents a control system according to the present invention.

### DETAILED DESCRIPTION OF AN EMBODIMENT

FIG. 1 shows a possible control diagram of one or more machines installed on an industrial vehicle or one or more members of a machine tool generically indicated with the reference numeral 1. They also comprise sensors and actuator mechanisms (generically indicated with the reference numeral 3) which can be directly connected, in a suitable way, to the control unit 2, which may be of different types (for example, it may comprise a PC or a PLC and a switchboard), and which can be suitably operated therefrom. For example, the machinery can be vacuum and pressure pumps, the oil engines and relative pumps, and the engine (for example a diesel engine) of the industrial vehicle described in EP A 992 635. The diagram also shows the remote unit 4 capable, as said above, of exchanging data with the control unit 2. As stated, the remote unit is equipped with a memory and is programmable. It can have a monitor, for example a liquid crystal monitor, preferably equipped with touch screen functionality to allow commands to be entered simply by touching the various parts of the screen. Management software can be memorized thereon to allow, for example, a diagram of the system to be controlled to be viewed on the monitor together with the operating parameters, received from the control unit and processed by the software. It is also possible to provide a fault detection system capable of providing a view of the part concerned, together with the relevant data. Thanks to the memory and programmability of the remote unit, the data to be exchanged between the control unit and the remote unit will be reduced to a minimum, as they may relate only to the instantaneous operating parameters and the commands to be executed, while a series of data relative to the structure of the equipment is already memorized in the remote unit. The software of the remote unit also allows the commands entered by the operator to be processed and sent to the control unit in an appropriate way. The control unit can also be equipped with a memory and be equipped with management software to control operation of the machinery or of the members of the machine tool: for example, with the appropriate modifications (relative to exchanging data and receiving commands from the remote unit), the control unit can have the same functionality as the logic unit described in EP A 992 635.

The control and remote units are equipped with suitable means for data exchange via radio. This exchange can take place according to known protocols and with known technologies (for example, RS 232, RS 485, RS 422, Bluetooth, 802.11b, WIFI . . . ). An emergency system may be provided, so that the control unit must receive a continuous signal from the remote unit to allow normal operation of the machine tool or of the machinery. If the signal is interrupted (for example, because of a specific command by the operator), a series of suitable emergency commands are actuated, which, for example, may comprise the shutdown of all the equipment.

The remote unit will preferably be equipped with an electrical power source to allow operation thereof, such as batteries, more preferably rechargeable batteries. According to a preferred aspect, the remote unit is equipped with a system to recharge the batteries comprising means for the electrical connection to an electrical power source of the machine tool or industrial vehicle, such as the batteries and/or the electrical power generator. Also preferably present on the vehicle or machine tool are electrical connection means compatible with the connection means present on the remote unit. The electrical connection means may be plugs and/or sockets of a suitable form. The remote unit can thus, when it is not in use, or when it can be used even if connected to the machine tool or vehicle, be connected in order to recharge the rechargeable batteries. In this case, connection means for cable data transmission may also be present, with automatic exclusion of the radio transmission when the remote unit is connected to the machine tool or vehicle.

The remote unit can also have form and size suitable for the conditions under which the operator is required to work. For example, it can be provided with straps to allow the operator to wear it and view the monitor, if present, without requiring to use his hands.

Machine tool is intended as a machine which may be movable, in the sense that it can be moved autonomously, for example on wheels or tracks, or also fixed, such as a construction site crane.

1. Control method for machine tools and/or machinery installed on industrial vehicles comprising:
providing, on said machine tool or said industrial vehicle, a control unit capable of controlling the various members of said machine tool or the machinery installed on said vehicle;
providing a remote unit capable of exchanging data via radio with said control unit, said remote unit being equipped with a memory and being programmable.

2. Method as claimed in claim 1 wherein said remote unit is equipped with a monitor.

3. Method as claimed in claim 2 wherein said remote unit is equipped with touch screen functionality.

4. Method as claimed in any of the previous claims wherein said remote unit is equipped with rechargeable batteries.

5. Method as claimed in claim 4 wherein said remote unit is equipped with means for the electrical connection to an electrical power source of the machine tool or industrial vehicle.

6. Control system for a machine tool or machinery installed on an industrial vehicle comprising a control unit and a remote unit as defined in claim 1.

7. Industrial vehicle comprising a series of machinery and a control system for said machinery as defined in claim 6.
